(19) United States
(12) Patent Application Publication
(10) Pub. No.: US 2015/0131992 A1
(43) Pub. Date: May 14, 2015

(54) METHOD AND APPARATUS FOR OPTICAL SIGNAL CONTROL USING FILTER IN MULTICASTING RING NETWORK NODE AND PROTECTION SWITCHING IN OPTICAL MULTIPLEX SECTION

(71) Applicant: Electronics and Telecommunications Research Institute, Daejeon (KR)

(72) Inventors: Hyun Jae LEE, Daejeon (KR); Bheom Soon JOO, Daejeon (KR)

(21) Appl. No.: 14/307,746

(22) Filed: Jun. 18, 2014

(30) Foreign Application Priority Data
Nov. 11, 2013 (KR) 10-2013-0136417

(51) Int. Cl. H04B 10/275; H04J 14/02; H04Q 11/00

(52) U.S. Cl. CPC H04B 10/275; H04Q 11/0005; H04J 14/0213; H04J 14/0294; H04Q 2011/0047; H04Q 2011/0009; H04Q 2011/0092
USPC 398/48

(57) ABSTRACT

A method and apparatus for optical signal control using a filter in a multicasting ring network node and protection switching in an optical multiplex section is disclosed, in which a multicasting ring network node extracts or passes a wavelength from a node requiring optical signal wavelength extraction, transmits the passed optical signal to a neighboring node through control as necessary, and readily performs protection switching on an optical multiplex section signal.

### CROSS-REFERENCE TO RELATED APPLICATION

This application claims the priority benefit of Korean Patent Application No. 10-2013-0136417, filed on Nov. 11, 2013, in the Korean Intellectual Property Office, the disclosure of which is incorporated herein by reference.

### BACKGROUND

1. Field of the Invention

The present invention relates to a method and apparatus for operating optical channels in a multicasting ring network node.

2. Description of the Related Art

Functions of protection switching to be applied to a ring-type add drop multiplex (ADM) network node structure correspond to 1+1 switching of a point to point network structure, and characteristics of protection switching are as follows:
Protection switching method: Unidirectional protection switching is performed. When protection switching is applied, unidirectional protection switching is performed in a reception node, and protection switching is characterized as being revertive or non-revertive.
Traffic signal operation method: A diverse routing method is used for transmitting traffic signals between a uniform routing method and a diverse routing method.

### SUMMARY

An aspect of the present invention provides a method and apparatus for continuously transmitting passed optical signals to neighboring nodes by controlling/cutting off a wavelength as necessary based on a method of extracting/passing a wavelength in a node in which extraction of an optical signal wavelength is required. In general, a number of transmitters required for re-transmission in a node is equal to a number of optical channels received from the node. The present invention allows a multicasting ring network node to receive all channels transmitted via an optical fiber based on a wavelength multicasting method in a multicasting ring network node. Also, cost efficient transmission is made possible when new signals are transmitted since not all channels are re-transmitted, as only necessary channels aside from signals passing through are added to be transmitted, using a transmitter. For example, implementing a multicasting ring network node that may reduce capital expenditure (Capex) and operational expenditure (Opex) is possible because only necessary channels to be transmitted directly or through use of a transmitter to a neighboring node, with respect to all extracted channels, are received. Accordingly, such a configuration may be simple because protection switching of an optical signal is performed by a multiplex section rather than a plurality of individual channels. In addition, when a problem occurs on a signal line, a method of protection switching for all optical signals may be provided.

Another aspect of the present invention also provides a method that allows flexible operation of a wavelength through cutting off and inserting signals in plurality of multicasting ring network nodes, and enhances efficiency of wavelength use by cutting off an optical signal in a neighboring multicasting ring network node prior to a multicasting ring network node from which the optical signal is transmitted and inserting a new optical signal into the neighboring multicasting ring network node.

According to an aspect of the present invention, there is provided an apparatus for operating traffic signals, the apparatus including a first signal line configured to transmit first optical signals of a plurality of channels, a second signal line configured to transmit second optical signals of a plurality of channels, a multiplexer configured to multiplex and output a plurality of optical signals as third optical signals, a distributor configured to distribute the third optical signals to the first signal line and the second signal line, a first optical coupler configured to couple the third optical signals to the first optical signals transmitted through the first signal line, a second optical coupler configured to couple the third optical signals to the second optical signals transmitted through the second signal line, a first optical divider configured to extract at least a portion of the first optical signals transmitted through the first signal line, a second optical divider configured to extract at least a portion of the second optical signals transmitted through the second signal line, a first filter configured to cut off at least a portion of the first optical signals transmitted through the first signal line, and a second filter configured to cut off at least a portion of the second optical signals transmitted through the second signal line.

The apparatus for operating the traffic signals may further include a first optical amplifier configured to amplify an optical signal received from the first optical coupler, and a second optical amplifier configured to amplify an optical signal received from the second optical coupler.

The apparatus for operating the traffic signals may further include an optical switch configured to select one of the first signal line and the second signal line, and a de-multiplexer configured to divide optical signals of a signal line selected from the first signal line and the second signal line among a plurality of channels.

According to an aspect of the present invention, there is provided a method of operating traffic signals, the method including multiplexing and outputting a plurality of optical signals as third optical signals, distributing the third optical signals to a first signal line configured to transmit first optical signals of a plurality of channels and a second signal line configured to transmit second optical signals of a plurality of channels, respectively, coupling the first optical signals and the second optical signals to the third optical signals, extracting at least a portion from the first optical signals transmitted through the first signal line and at least a portion from the second optical signals transmitted through the second signal line and cutting off at least a portion of the first optical signals and the second optical signals coupled to the third optical signals.

The method of operating the traffic signals may further include amplifying the first optical signals and the second optical signals.

The method of operating traffic signals may further include selecting at least one of the first signal line and the second signal line, and dividing optical signals of a signal line selected from the first signal line and the second signal line among a plurality of channels.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for operating ring-type add drop multiplex (ADM) traffic, according to an embodiment of the present invention;

FIG. 2 is a diagram illustrating a method of wavelength control using a filter in a plurality of multicasting ring network nodes and multicasting, according to an embodiment of the present invention;

FIG. 3 is a diagram illustrating an apparatus for passing wavelength control using a filter in a multicasting ring network node and protection switching in an optical multiplex section according to an embodiment of the present invention; and

FIG. 4 is a flowchart illustrating a method of passing wavelength control using a filter in a multicasting ring network node and protection switching in an optical multiplex section according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

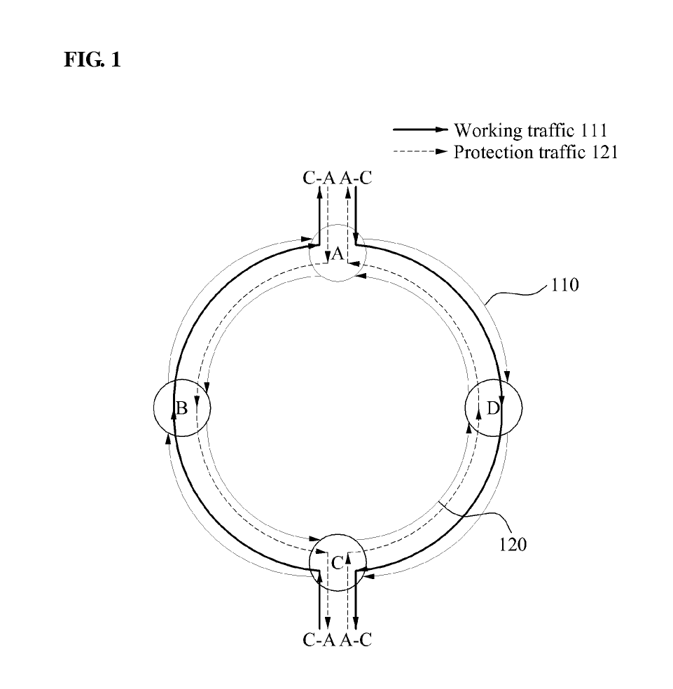

FIG. 1 is a diagram illustrating an apparatus for operating ring-type add drop multiplex (ADM) traffic according to an embodiment of the present invention.

Referring to FIG. 1, the apparatus for operating ring-type ADM traffic includes multicasting ring network nodes A, B, C, and D, a first signal line 110, and a second signal line 120. The first signal line 110 to transmit first optical signals of a plurality of channels is a working traffic signal 111, hereinafter also referred to as a working signal. Also, the second signal line 120 to transmit second optical signals of a plurality of channels is a protection traffic signal 121, hereinafter also referred to as a protection traffic signal. The first signal line 110 and the second signal line 120 transmit optical signals in opposite directions. The multicasting ring network nodes A, B, C, and D are connected to both the first signal line 110 and the second signal line 120. When an error occurs on the first signal line 110, the multicasting ring network nodes A, B, C, and D communicate using an optical signal transmitted to the second signal line 120.

For example, an optical signal input to the multicasting ring network node A connected to the first signal line 110 is extracted from the multicasting ring network node C via the multicasting ring network node D. An optical signal extracted from the multicasting ring network node C is re-input to the multicasting ring network node C, and extracted from the multicasting ring network node A via the multicasting ring network node B.

Conversely, an optical signal input to the multicasting ring network node A connected to the second signal line 120 is extracted from the multicasting ring network node C via the multicasting ring network node B. An optical signal extracted from the multicasting ring network node C is re-input to the multicasting ring network node C, and extracted from the multicasting ring network node A via the multicasting ring network node D.

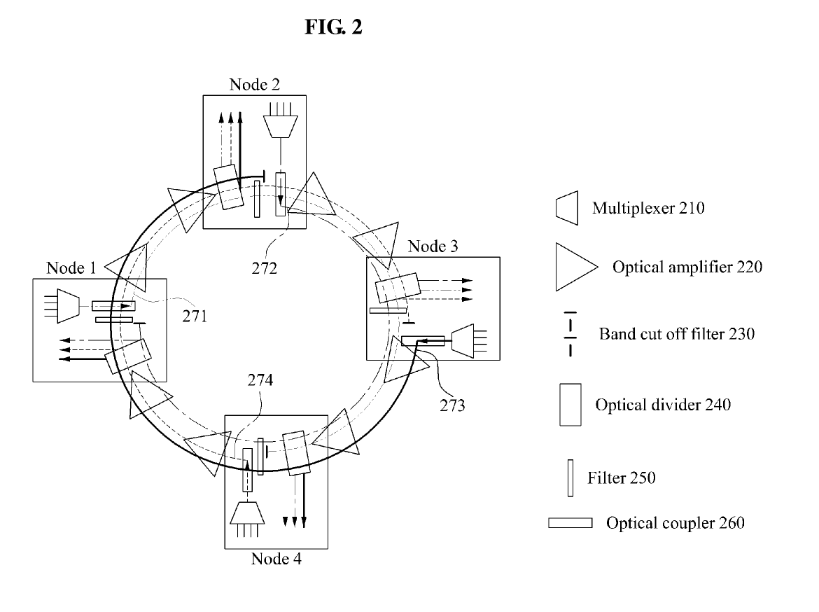

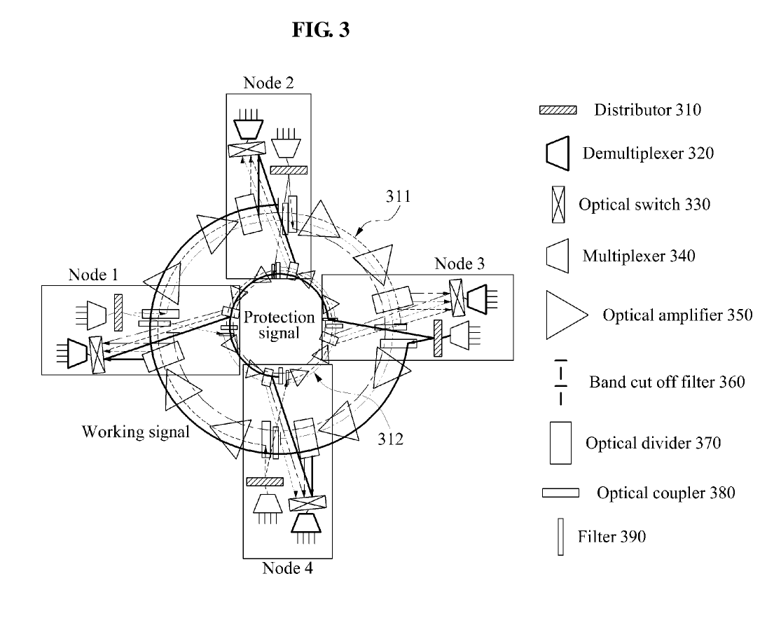

A method and apparatus for passing wavelength control using a filter in a plurality of multicasting ring network nodes and protection switching in an optical multiplex section according to an exemplary embodiment of the present invention will be described later with reference to FIGS. 2 and 3.

FIG. 2 is a diagram illustrating a method of wavelength control using a filter in a plurality of multicasting ring network nodes and multicasting according to an embodiment of the present invention.

An apparatus for wavelength control using a filter in a plurality of multicasting ring network nodes and multicasting includes multicasting ring network nodes, for example, Node 1, Node 2, Node 3, and Node 4. The plurality of multicasting ring network nodes Node 1, Node 2, Node 3, and Node 4 is connected to a signal line to transmit first optical signals of a plurality of channels. Also, the plurality of multicasting ring network nodes Node 1, Node 2, Node 3, and Node 4 includes a multiplexer 210, an optical amplifier 220, a band cut off filter 230, an optical divider 240, a filter 250, and an optical coupler 260.

Referring to FIG. 2, the plurality of multicasting ring network nodes Node 1, Node 2, Node 3, and Node 4 extracts or passes optical signals transmitted from other nodes using the optical divider 240. Alternatively, a portion of the optical signals may be cut off as necessary.

The multiplexer 210 multiplexes and outputs a plurality of optical signals as third optical signals to the plurality of multicasting ring network nodes Node 1, Node 2, Node 3, and Node 4.

The optical coupler 260 couples the first optical signals to the third optical signals. For example, the optical coupler 260 of a signal line may couple the third optical signals to the first optical signals transmitted through the signal line. In this instance, the first optical signals include the first optical signals transmitted through the signal line and the third optical signals. Also, the optical coupler 260 adds the third optical signals to an area of the first optical signals transmitted through the signal line cut off by the filter 250.

By way of example, the optical coupler 260 couples the first optical signals to the third optical signals on a signal line 271 of the multicasting ring network node Node 1. Also, the optical coupler 260 couples the first optical signals to the third optical signals on a signal line 272 of the multicasting ring network node Node 2. Further, the optical coupler 260 couples the first optical signals to the third optical signals on a signal line 273 of the multicasting ring network node Node 3. In addition, the optical coupler 260 couples the first optical signals to the third optical signals on a signal line 274 of the multicasting ring network node Node 4.

The optical amplifier 220 amplifies the first optical signals. In this instance, the optical amplifier 220 compensates for optical signals reduced during extraction, passing, and channel coupling of optical signal channels. Also, the optical amplifier 220 compensates for an optical signal reduced during long-distance transmission.

The optical divider 240 extracts at least a portion of the first optical signals transmitted through a signal line. The optical divider 240 outputs optical signals by dividing among a plurality of channels, bands, or signals.

The plurality of multicasting ring network nodes Node 1, Node 2, Node 3, and Node 4 extracts and passes optical signals transmitted from other multicasting ring network nodes using the optical divider 240. The passed optical signals are transmitted to a neighboring multicasting ring network node connected via a ring. The neighboring multicasting ring network node also extracts and passes optical signals transmitted from other multicasting ring network nodes using the optical divider 240. Such a method allows efficient optical channel operation by minimizing photoelectric conversion. The plurality of multicasting ring network nodes Node 1, Node 2, Node 3, and Node 4 extracts and passes optical signals transmitted from all other nodes using the optical divider 240.

As an example, when the first optical signals transmitted through the signal line correspond to multicast signals including the multicasting ring network node Node 1 as a multicast receiver, the optical divider 240 of the multicasting ring network node Node 1 extracts the multicast signals from among the first optical signals. The filter 250 may pass the multicast signals from among the first optical signals.

As another example, when the first optical signals transmitted through the signal line correspond to unicast signals for which the multicasting ring network node Node 1 is a destination, the optical divider 240 of the multicasting ring network node Node 1 extracts the unicast signals from among the first optical signals. The filter 250 may cut off the unicast signals from among the first optical signals.

The filter 250 cuts off at least a portion of the first optical signals coupled to the third optical signals. For example, the filter 250 of the signal line cuts off at least a portion of the first optical signals transmitted through the signal line. Also, the filter 250 cuts off optical signals for a plurality of channels, bands, or signals. In particular, optical signals of a node transmitted to a neighboring node may be cut off by the neighboring node or the node using the band cut off filter 230. Accordingly, interference between optical signal channels transmitted from the node and optical signal channels transmitted from the neighboring node may be prevented. Through this, cutting off of a predetermined channel wavelength transmitted from a previous node, and cutting off of a band or entire channel wavelength may be possible, as necessary, by using the filter 250.

For example, the filter 250 cuts off fourth optical signals when the fourth optical signals transmitted from a subsequent node are included in the first optical signals transmitted through the signal line.

Also, a wavelength cut off by the multicasting ring network node Node 4, being a neighboring node prior to the multicasting ring network node Node 1 that transmitted the first optical signals may be re-added as another signal of an identical wavelength by the multicasting ring network node Node 4 that cut off the wavelength. Accordingly, the first optical signals are extracted from the multicasting ring network node Node 1 by adding and re-transmitting the first optical signals to the multicasting ring network node Node 1.

FIG. 3 is a diagram illustrating an apparatus for passing wavelength control using a filter in a multicasting ring network node and protection switching in an optical multiplex section according to an embodiment of the present invention.

The apparatus for passing wavelength control using the filter in the multicasting ring network node and protection switching in the optical multiplex section includes a first signal line 110, a second signal line 120, and multicasting ring network nodes, for example, Node 1, Node 2, Node 3, and Node 4. Here, first optical signals correspond to working signals, and second optical signals correspond to protection signals. A first signal line 311 and a second signal line 312 transmit optical signals in opposite directions. Also, the multicasting ring network nodes Node 1, Node 2, Node 3, and Node 4 are connected to both the first signal line 311 and the second signal line 312, respectively. When an error occurs in the first signal line 311, the multicasting nodes Node 1, Node 2, Node 3, and Node 4 communicate using optical signals transmitted through the second signal line 312. The first signal line 311 and the second signal line 312 connected to the plurality of multicasting nodes Node 1, Node 2, Node 3, and Node 4 include a multiplexer 340, a distributor 310, an optical coupler 380, an optical divider 370, a filter 390, a band cut off filter 360, an optical amplifier 350, an optical switch 330, and a demultiplexer 320.

The multiplexer 340 multiplexes and outputs a plurality of optical signals as third optical signals to the plurality of multicasting ring network nodes.

The distributor 310 distributes the third optical signals to the first signal line 311 configured to transmit first optical signals of a plurality of channels and the second signal line 312 configured to transmit second optical signals of a plurality of channels. For example, the plurality of multicasting nodes Node 1, Node 2, Node 3, and Node 4 divides outputs of a multiplex section multiplexing a plurality of optical signals and distributes to the first signal line 311 and the second signal line 312 using the distributor 310.

The optical coupler 380 couples the first optical signals and the second optical signals to the third optical signals, respectively. In particular, a first optical coupler of the first signal line 311 couples the third optical signals to the first optical signals transmitted to the first signal line 311. Also, a second optical coupler of the second signal line 312 couples the third optical signals to the second optical signals transmitted through the second signal line 312. Here, the first optical signals include the first optical signals and the third optical signals transmitted through the first signal line 311. Also, the second optical signals include the second optical signals and the third optical signals transmitted through the second signal line 312. Further, the first optical coupler adds the third optical signals to an area of the first optical signals transmitted through the first signal line cut off by the filter 390. The second optical coupler adds the third optical signals to an area of the second optical signals transmitted through the second signal line cut off by the filter 390.

The optical amplifier 350 amplifies the first optical signals and the second optical signals, respectively. More particularly, a first optical amplifier of the first signal line 311 amplifying optical signals received from the first optical coupler amplifies the first optical signals. A second optical amplifier of the second signal line 312 amplifying optical signals received from the second optical coupler amplifies the second optical signals. The optical amplifier 350 compensates for optical signals reduced during extraction, passing, and channel coupling of optical signal channels. Also, the optical amplifier 350 compensates for optical signals reduced during long-distance transmission.

The optical divider 370 extracts at least a portion of the first optical signals transmitted through the first signal line 311 and the second optical signals transmitted through the second signal line 312, respectively. In particular, a first optical divider of the first signal line extracts at least a portion of the first optical signals transmitted through the first signal line. Also, a second optical divider of the second signal line 312 extracts at least a portion of the second optical signals transmitted through the second signal line 312. The first optical divider and the second optical divider output optical signals through division among a plurality of channels, bands, or signals.

The plurality of multicasting ring network nodes Node 1, Node 2, Node 3, and Node 4 extracts or passes optical signals transmitted from other multicasting ring network nodes using the optical divider 370. The passed optical signals are transmitted to a neighboring multicasting ring network node connected via a ring. The neighboring multicasting ring network node also extracts or passes optical signals transmitted from other multicasting ring network nodes using the optical divider 370. Such a method enables efficient optical channel operation by minimizing photoelectric conversion. When a method of protection switching in an optical multiplex section is applied to the multicasting ring network nodes Node 1, Node 2, Node 3, and Node 4, optical signals transmitted from all other nodes are extracted or passed using the optical divider 370. In particular, optical signals extracted from the multicasting ring network nodes Node 1, Node 2, Node 3, and Node 4 select one of the first optical signals transmitted through the first signal line 311 and the second optical signals transmitted through the second signal line 312 using the optical switch 330. Accordingly, protection switching is performed in such a manner that optical signals are transmitted to a node of a lower network or another network.

As an example, when the first optical signals transmitted through the first signal line 311 correspond to multicast signals including the multicasting ring network node Node 1 of the first optical divider as a multicast receiver, the first optical divider of the multicasting ring network node Node 1 extracts the multicast signals from among the first optical signals. A first filter passes the multicast signals from among the first optical signals. Also, when the second optical signals transmitted through the second signal line 312 correspond to multicast signals including the multicasting ring network node Node 2 of the second optical divider as a multicast receiver, the second optical divider of the multicasting ring network node Node 2 extracts the multicast signals from among the second optical signals. Also, a second filter passes the multicast signals from among the second optical signals.

As another example, when the first optical signals transmitted through the first signal line 311 correspond to unicast signals for which the multicasting ring network node Node 1 of the first optical divider is a destination, the first optical divider of the multicasting ring network node Node 1 extracts the unicast signals from among the first optical signals. The first filter cuts off the unicast signals from among the first optical signals. Also, when the second optical signals transmitted through the second signal line 312 correspond to unicast signals for which the multicasting ring network node Node 2 of the second optical divider is a destination, the second optical divider of the multicasting ring network node Node 2 extracts the unicast signals from among the second optical signals. Also, the second filter cuts off the unicast signals from among the second optical signals.

The filter 390 cuts off at least a portion of the first optical signals and the second optical signals coupled to the third optical signals, respectively. In particular, the first filter of the first signal line 311 cuts off at least a portion of the first optical signals transmitted through the first signal line 311. Also, the second filter of the second signal line 312 cuts off at least a portion of the second optical signals transmitted through the second signal line 312. The first filter and the second filter cut off optical signals for a plurality of channels, bands, and signals. More particularly, optical signals of a node transmitted to a neighboring node are cut off by the node or the neighboring node using the band cut off filter 360. Accordingly, interference between optical signal channels transmitted from the node and optical signal channels transmitted from the neighboring node may be prevented. Through this, cutting off of a predetermined channel wavelength transmitted from a previous node, and cutting off of a band or entire channel wavelength may be possible, as necessary, by using the filter 390.

For example, the first filter cuts off fourth optical signals when the fourth optical signals transmitted from a subsequent node are included in the first optical signals transmitted through the first signal line 311. Also, the second filter cuts off fifth optical signals when the fifth optical signals transmitted from a subsequent node are included in the second optical signals transmitted through the second signal line 312.

Also, a wavelength cut off by the multicasting ring network node Node 4, being a neighboring node prior to the multicasting ring network node Node 1 that transmitted the first optical signals may be re-added as another signal of an identical wavelength by the multicasting ring network node Node 4 that cut off the wavelength. Through this, the first optical signals are extracted from the multicasting ring network node Node 1 by adding and re-transmitting the first optical signals to the multicasting ring network node Node 1. Thus, efficient use of optical signals may be achieved.

The optical switch 330 selects one of the first signal line 311 and the second signal line 312. In particular, the optical switch 330 selects one of the first signal line 311 configured to transmit the first optical signals of a plurality of channels and the second signal line 312 configured to transmit the second optical signals of a plurality of channels. By way of example, one of a working signal and a protection signal is selected. The first signal line 311 and the second signal line 312 transmit optical signals in opposite directions. Also, the plurality of multicasting ring network nodes is connected to the first signal line 311 and the second signal line 312, respectively. Accordingly, when an error occurs on the first signal line 311, the plurality of multicasting ring network nodes communicates using optical signals transmitted through the second signal line 312.

The demultiplexer 320 divides optical signals of a signal line selected from the first signal line 311 and the second signal line 312 among a plurality of channels. Protection switching is performed in such a manner that optical signals are transmitted to a node of a lower network or another network.

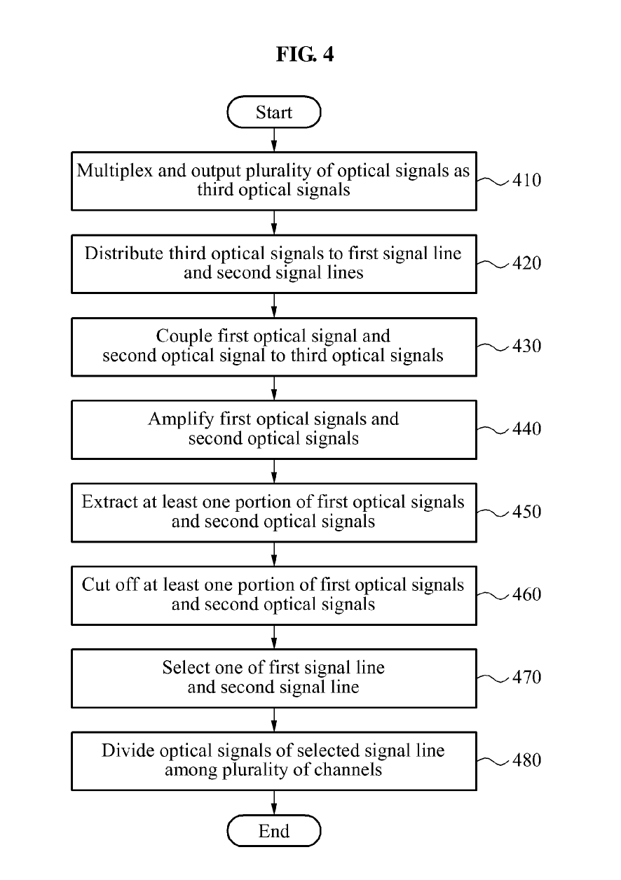

FIG. 4 is a flowchart illustrating a method of passing wavelength control using a filter in a multicasting ring network node and protection switching in an optical multiplex section according to an embodiment of the present invention.

The method of passing wavelength control using the filter in the multicasting ring network node and protection switching in the optical multiplex section includes multiplexing and outputting a plurality of optical signals as third optical signals in operation 410, distributing the third optical signals to a first signal line and a second signal line in operation 420, coupling first optical signals and second optical signals to the third optical signals, respectively, in operation 430, amplifying the first optical signals and the second optical signals, respectively, in operation 440, extracting at least a portion of the first optical signals and the second optical signals in operation 450, cutting off at least a portion of the first optical signals and the second optical signals in operation 460, selecting one of the first signal line and the second signal line in operation 470, and dividing optical signals of a selected signal line among a plurality of channels in operation 480.

In operation 410, a multiplexer multiplexes and outputs a plurality of optical signals as the third optical signals to a multicasting ring network node. A multicasting ring network node device includes the first signal line configured to transmit the first optical signals of a plurality of channels and the second signal line configured to transmit the second optical signals of a plurality of channels. In this instance, the first optical signals correspond to working signals, and the second optical signals correspond to protection signals. The first signal line and the second signal line transmit optical signals in opposite directions. Also, a plurality of multicasting ring network nodes is connected to both the first signal line and the second signal line. When an error occurs on the first signal line, the multicasting ring network nodes communicate using an optical signal transmitted through the second signal line.

In operation 420, the multicasting ring network nodes distribute the third optical signals to the first signal line configured to transmit the first optical signals of the plurality of channels and to the second signal line configured to transmit the second optical signals of the plurality of channels. For example, the plurality of multicasting ring network nodes separates optical signals from outputs of a multiplexer multiplexing a plurality of optical signals, and distributes to the first signal line and the second signal line.

In operation 430, the first optical signals and the second optical signals are coupled to the third optical signals, respectively. In particular, a first optical coupler couples the third optical signals to the first optical signals transmitted through the first signal line. Also, a second optical coupler couples the third optical signals to the second optical signals transmitted through the second signal line. In this instance, the first optical signals include the first optical signals transmitted through the first signal line and the third optical signals. Further, the second optical signals include the second optical signals transmitted through the second signal line and the third optical signals. The first optical coupler adds the third optical signals to an area of the first optical signals transmitted through the first signal line cut off by a filter. The second optical coupler adds the third optical signals to an area of the second optical signals transmitted through the second signal line cut off by a filter.

In operation 440, the first optical signals and the second optical signals are amplified. As an example, a first optical amplifier configured to amplify optical signals received from the first optical coupler amplifies the first optical signals, and a second optical amplifier configured to amplify optical signals received from the second optical coupler amplifies the second optical signals. Here, the optical amplifier compensates for optical signals reduced during extraction, passing, and channel coupling of optical signal channels. Also, the optical amplifier compensates for optical signals reduced during long-distance transmission.

In operation 450, at least a portion of the first optical signals transmitted through the first signal line and at least a portion of the second optical signals transmitted through the second optical signal line are extracted, respectively. In particular, a first optical divider extracts at least a portion of the first optical signals transmitted through the first signal line. Also, a second optical divider extracts at least a portion of the second optical signals transmitted to the second optical line. The first optical divider and the second optical divider output optical signals by dividing among a plurality of channels, bands, or signals.

The multicasting ring network nodes extract or pass optical signals using an optical divider extracting or passing optical signals transmitted from other multicasting ring network nodes. The passed optical signals are transmitted to a neighboring multicasting ring network node connected via a ring. The neighboring multicasting ring network node also extracts or passes optical signals transmitted from other multicasting ring network nodes using an optical divider. Such a method enables efficient optical channel operation by minimizing photoelectric conversion. When a method of protection switching in an optical multiplex section is applied to such a multicasting ring network node, optical signals transmitted from all other nodes are extracted or passed using an optical divider. In particular, optical signals extracted from a plurality of nodes select one of the first optical signals transmitted through the first signal line and the second optical signals transmitted through the second signal line. Accordingly, protection switching is performed in such a manner that optical signals are transmitted to a node of a lower network or another network.

As an example, when the first optical signals transmitted through the first signal line correspond to multicast signals including the multicasting ring network node of the first optical divider as a multicast receiver, the first optical divider extracts the multicast signals from among the first optical signals. A first filter passes the multicast signals from among the first optical signals. Also, when the second optical signals transmitted through the second signal line correspond to multicast signals including the multicasting ring network node of the second optical divider as a multicast receiver, the second optical divider extracts the multicast signals from among the second optical signals. Also, a second filter passes the multicast signals from among the second optical signals.

As another example, when the first optical signals transmitted through the first signal line correspond to unicast signals for which the multicasting ring network node of the first optical divider is a destination, the first optical divider extracts the unicast signals from among the first optical signals. The first filter cuts off the unicast signals from among the first optical signals. Also, when the second optical signals transmitted through the second signal line correspond to unicast signals for which the multicasting ring network node of the second optical divider is a destination, the second optical divider extracts the unicast signals from among the second optical signals. Also, the second filter cuts off the unicast signals from among the second optical signals.

In operation 460, the filter cuts off at least a portion of the first optical signals and the second optical signals coupled to the third optical signals. For example, the first filter cuts off at least a portion of the first optical signals transmitted through the first signal line. Also, the second filter cuts off at least a portion of the second optical signals transmitted through the second signal line. The first filter and the second filter cut off optical signals for a plurality of channels, bands, and signals. In particular, optical signals of a node transmitted to a neighboring node are cut off by the node or the neighboring node using a band cut off filter. Accordingly, interference between optical signal channels transmitted from the node and optical signal channels transmitted from the neighboring node may be prevented. Through this, cutting off of a predetermined channel wavelength transmitted from a previous node, and cutting off of a band or entire channel wavelength may be possible using the filter as necessary.

For example, the first filter cuts off fourth optical signals when the fourth optical signals transmitted from a subsequent node are included in the first optical signals transmitted through the first signal line. Also, the second filter cuts off fifth optical signals when the fifth optical signals transmitted from a subsequent node are included in the second optical signals transmitted through the second signal line.

Also, a wavelength cut off by a second node, being a neighboring node prior to a first node that transmitted the first optical signals may be re-added as another signal of an identical wavelength by the second node that cut off the wavelength. Through this, the first optical signals are extracted from the first node by adding the first optical signals and re-transmitting the first optical signals to the first node. Thus, efficient use of optical signals may be achieved.

In operation 470, one of the first signal line and the second signal line is selected using an optical switch. In particular, one of the first signal line configured to transmit the first optical signals of a plurality of channels and the second signal line configured to transmit the second optical signals of a plurality of channels is selected. By way of example, one of a working signal and a protection signal is selected. The first signal line and the second signal line transmit optical signals in opposite directions. Also, the plurality of multicasting ring network nodes is connected to the first signal line and the second signal line, respectively. Accordingly, when an error occurs on the first signal line, the plurality of multicasting ring network nodes communicates using optical signals transmitted through the second signal line.

In operation 480, optical signals of a signal line selected from the first signal line and the second signal line are divided among a plurality of channels. Protection switching is performed in such a manner that optical signals are transmitted to a node of a lower network or another network.

According to the present exemplary embodiment, it is possible to efficiently configure a multicasting ring network node in an optical network. Also, protection switching of optical multiplex section signals in a multicasting ring network node may be easily configured. Accordingly, capital expenditure (Capex) and operational expenditure (Opex) may be reduced. An implementation of a network configuration efficiently using a wavelength in multicasting transmission may be realized due to addition of an inserted channel through wavelength control of passing channels.

According to the present exemplary embodiment, there is provided a method of performing protection switching on optical signals in an optical multiplex section in which an extraction node extracts optical signals from transmitted working signals and protection signals. Also, an optical multiplex section may securely operate signals transmitted via a signal line through protection switching by selecting the extracted optical signals using a switch as necessary. When a signal is inserted, signals to be coupled may be multiplexed, divided using an optical divider, and inserted into a working line and a protection line. Passing signals may be passed in an original form of optical signals without photoelectric conversion, and a portion or a total of the optical signals may be cut off as necessary. Also, signal crosstalk may be prevented because optical signals transmitted from a previous multicasting ring network node are cut off using a cut off filter. The method of performing protection switching on the optical signals in the optical multiplex section allows a simple system structure and provides functions of protection switching on multicasting optical signals in a multiplex section.

According to the present exemplary embodiment, it is possible to expand a range of services available in local areas to other areas through extracting, passing, for example, signal control, and inserting, for example, inserted signal control. Also, when the method of performing protection switching on the optical signals is employed in an optical multiplex section, multicasting optical signals may be securely operated on a line through a working signal and a protection signal. Further, when a passing optical wavelength is controlled using a filter, a wavelength signal may be efficiently utilized by further inserting and extracting an optical wavelength.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for operating traffic signals, the apparatus comprising:
a first signal line configured to transmit first optical signals of a plurality of channels;
a second signal line configured to transmit second optical signals of a plurality of channels;
a multiplexer configured to multiplex and output a plurality of optical signals as third optical signals;
a distributor configured to distribute the third optical signals to the first signal line and the second signal line;
a first optical coupler configured to couple the third optical signals to the first optical signals transmitted through the first signal line;
a second optical coupler configured to couple the third optical signals to the second optical signals transmitted through the second signal line;
a first optical divider configured to extract at least a portion of the first optical signals transmitted through the first signal line;
a second optical divider configured to extract at least a portion of the second optical signals transmitted through the second signal line;
a first filter configured to cut off at least a portion of the first optical signals transmitted through the first signal line; and
a second filter configured to cut off at least a portion of the second optical signals transmitted through the second signal line.

2. The apparatus of claim 1, further comprising:
a first optical amplifier configured to amplify an optical signal received from the first optical coupler; and
a second optical amplifier configured to amplify an optical signal received from the second optical coupler.

3. The apparatus of claim 1, further comprising:
an optical switch configured to select one of the first signal line and the second signal line; and
a de-multiplexer configured to divide optical signals of a signal line selected from the first signal line and the second signal line among a plurality of channels.

4. The apparatus of claim 1, wherein the first signal line transmits a working signal, and
the second signal line transmits a protection signal.

5. The apparatus of claim 4, wherein the first signal line and the second signal line transmit an optical signal in opposite directions, and
multicasting ring network nodes are connected to both of the first signal line and the second signal line, respectively, and communicate using an optical signal transmitted to the second signal when an error occurs on the first signal line.

6. The apparatus of claim 1, wherein the first optical coupler adds the third optical signals to an area of the first optical signals transmitted through the first signal line cut off by the first filter, and
the second optical coupler adds the third optical signals to an area of the second optical signals transmitted through the second signal line cut off by the second filter.

7. The apparatus of claim 1, wherein when the first optical signals transmitted through the first signal line correspond to multicast signals including a multicasting ring network node of the first optical divider as a multicast receiver, the first optical divider extracts the multicast signals from among the first optical signals, and the first filter passes the multicast signals from among the first optical signals, and
when the second optical signals transmitted through the second signal line correspond to multicast signals including a multicasting ring network node of the second optical divider as a multicast receiver,
the second optical divider extracts the multicast signals from among the second optical signals, and the second filter passes the multicast signals from among the second optical signals.

8. The apparatus of claim 1, wherein when the first optical signals transmitted through the first signal line correspond to unicast signals for which a destination is a multicasting ring network node of the first optical divider, the first optical divider extracts the unicast signals from among the first optical signals, and the first filter cuts the unicast signals off from among the first optical signals, and
when the second optical signals transmitted through the second signal line correspond to unicast signals for which a destination is a multicasting ring network node of the second optical divider,
the second optical divider extracts the unicast signals from among the second optical signals, and the second filter cuts off the unicast signals from among the second optical signals.

9. The apparatus of claim 1, wherein the first optical divider and the second optical divider output optical signals by dividing among a plurality of channels, bands, or signals.

10. The apparatus of claim 1, wherein the first optical divider and the second optical divider cut off optical signals for a plurality of channels, bands, or signals.

11. The apparatus of claim 10, wherein when a fourth optical signal transmitted by a subsequent multicasting ring network node is included in the first optical signals transmitted through the first signal line, the first filter cuts off the fourth optical signal, and
when a fifth optical signal transmitted by a subsequent multicasting ring network node is included in the second optical signals transmitted through the second signal line, the second filter cuts off the fifth optical signal.

12. An apparatus for operating traffic signals, the apparatus comprising:
a first signal line provided in a ring form and a second signal line provided in a ring form,
wherein the first signal line and the second signal line comprise a plurality of multicasting ring network nodes connected sequentially.

13. A method of operating traffic signals, the method comprising:
multiplexing and outputting a plurality of optical signals as third optical signals;
distributing the third optical signals to a first signal line configured to transmit first optical signals of a plurality of channels and to a second signal line configured to transmit second optical signals of a plurality of channels, respectively;
coupling the first optical signals and the second optical signals to the third optical signals;
extracting at least a portion from the first optical signals transmitted through the first signal line and at least a portion from the second optical signals transmitted through the second signal line; and
cutting off at least a portion of the first optical signals and the second optical signals coupled to the third optical signals.

14. The method of claim 13, further comprising:
amplifying the first optical signals and the second optical signals.

15. The method of claim 13, further comprising:
selecting at least one of the first signal line and the second signal line; and
dividing optical signals of a signal line selected from the first signal line and the second signal line among a plurality of channels.

16. The method of claim 15, wherein the selecting of the at least one of the first optical signals and the second optical signals comprises communicating using an optical signal transmitted through the second signal line when an error occurs on the first signal line.

17. The method of claim 13, wherein the coupling of the first optical signals and the second optical signals to the third optical signals comprises adding the third optical signals to an area of the first optical signals transmitted through the first signal line cut off by a filter, and adding the third optical signals to an area of the second optical signals transmitted through the second signal line cut off by a filter.

18. The method of claim 13, wherein the extracting of at least a portion of the first optical signals transmitted through the first signal line and at least a portion of the second optical signals transmitted through the second signal line comprises:
extracting, by a multicasting ring network node, being a multicast receiver from among multicasting ring network nodes receiving the first optical signals and the second optical signals, multicast signals from the first optical signals and the second optical signals when the first optical signals and the second optical signals correspond to the multicast signals, and passing, by the multicasting ring network node, the first optical signals and the second optical signals.

19. The method of claim 13, wherein the cutting off of at least a portion of the first optical signals and the second optical signals coupled to the third optical signals comprises:
cutting off a fourth optical signal and a fifth optical signal when the fourth optical signal and the fifth optical signal transmitted by a subsequent multicasting ring network node are included in the first optical signals transmitted through the first signal line and the second optical signals transmitted through the second signal line.
